(19) United States
(12) Patent Application Publication
(10) Pub. No.: US 2010/0320659 A1
(43) Pub. Date: Dec. 23, 2010

(54) PLATE SPRING FOR A VOICE COIL MOTOR

(76) Inventors: Ying-Jui Chen, Taichung (TW); Yu-Chun Huang, Taichung (TW)

Correspondence Address: TROP, PRUNER & HU, P.C., 1616 S. VOSS ROAD, SUITE 750, HOUSTON, TX, 77057-2631, US

(21) Appl. No.: 12/814,895

(22) Filed: Jun. 14, 2010

(30) Foreign Application Priority Data
Jun. 23, 2009 (TW) 098121006

(51) Int. Cl. F16F 1/32

(52) U.S. Cl. 267/158

(57) ABSTRACT

A plate spring includes an internal surrounding portion, an external surrounding portion, and a plurality of suspending arms. The external surrounding portion surrounds the internal surrounding portion and is spaced apart from the internal surrounding portion. The suspending arms interconnect the internal surrounding portion and the external surrounding portion. Each of the suspending arms includes a first connecting segment, a second connecting segment, and a working segment. The first connecting segment is connected to the external surrounding portion and extends inwardly. The second connecting segment is connected to the internal surrounding portion and extends outwardly. The working segment interconnects the first and second connecting segments and is formed with a plurality of hole portions which are spaced apart from each other.

### CROSS-REFERENCE TO RELATED APPLICATION

This application claims priority of Taiwanese Application No. 098121006, filed on Jun. 23, 2009.

### BACKGROUND OF THE INVENTION

1. Field of the Invention

The present invention relates to a component of an optical variable focus lens, more particularly to a plate spring for a voice coil motor.

2. Description of the Related Art

Referring to FIG. 1, a conventional auto-focusing lens device includes a voice coil motor (VCM) 1 and a lens 2. The voice coil motor 1 has a case 101, a yoke 102 disposed in the case 101, upper and lower plate springs 103 disposed in the case 101, a carrier 104 connected to the plate springs 103, a magnet set 105 disposed on the yoke 102, and a coil 106 disposed on the carrier 104. The lens 2 is locked threadedly in the carrier 104. As shown in FIG. 2, each of the plate springs 103 has an external surrounding portion 107, an internal surrounding portion 108, and a plurality of suspending arms 109 extending between the internal and external surrounding portions 108, 107. When electric current flows through the coil 106, the voice coil motor 1 works in accordance with the principle of Lorentz force, i.e., F=r×I×L×B, wherein F is a force of a coil; r is a ratio of a length of the coil in the magnetic field to a total length of the coil; I represents current through the coil; L is a total length of the coil; and B is magnetic flux density. Thus, axial thrust (i.e., Lorentz force) may be generated on the carrier 104 for moving the lens 2. At this moment, the main function of the plate springs 103 is to provide a reaction force for balancing Lorentz force, such that the lens 2 is movable to a predetermined position according to focusing requirements of an object whose image is to be captured, and can be fixed thereat until the image capturing operation is finished. However, a width and a thickness of each suspending arm 109 of the plate springs 103 are merely 0.1 mm and 0.05 mm, respectively, meaning that anti-torsion strength is poor, and the suspending arms 109 are easily damaged during a process of assembling the lens 2.

Referring to FIG. 3, Japanese patent Publication No. 2007-322540 discloses a plate spring 3 for a camera module. The plate spring 3 has a plurality of suspending arms 301. Each of the suspending arms 301 is formed with a slit 302 for avoiding stress concentration, and for alleviating a deformation problem of the plate spring 3 when the camera module is dropped. However, the anti-torsion strength of the plate spring 3 is still not good. Therefore, how to design a plate spring, which possesses good anti-torsion strength without changing axial elasticity, is an important issue in the industry.

### SUMMARY OF THE INVENTION

Therefore, the object of the present invention is to provide a plate spring for a voice coil motor, which has enhanced anti-torsion strength.

Accordingly, a plate spring of the present invention comprises an internal surrounding portion, an external surrounding portion, and a plurality of suspending arms. The external surrounding portion surrounds the internal surrounding portion and is spaced apart from the internal surrounding portion. The suspending arms interconnect the internal surrounding portion and the external surrounding portion. Each of the suspending arms includes a first connecting segment, a second connecting segment, and a working segment. The first connecting segment is connected to the external surrounding portion and extends inwardly. The second connecting segment is connected to the internal surrounding portion and extends outwardly. The working segment interconnects the first and second connecting segments and is formed with a plurality of hole portions which are spaced apart from each other.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic sectional view of a conventional auto-focusing lens device;

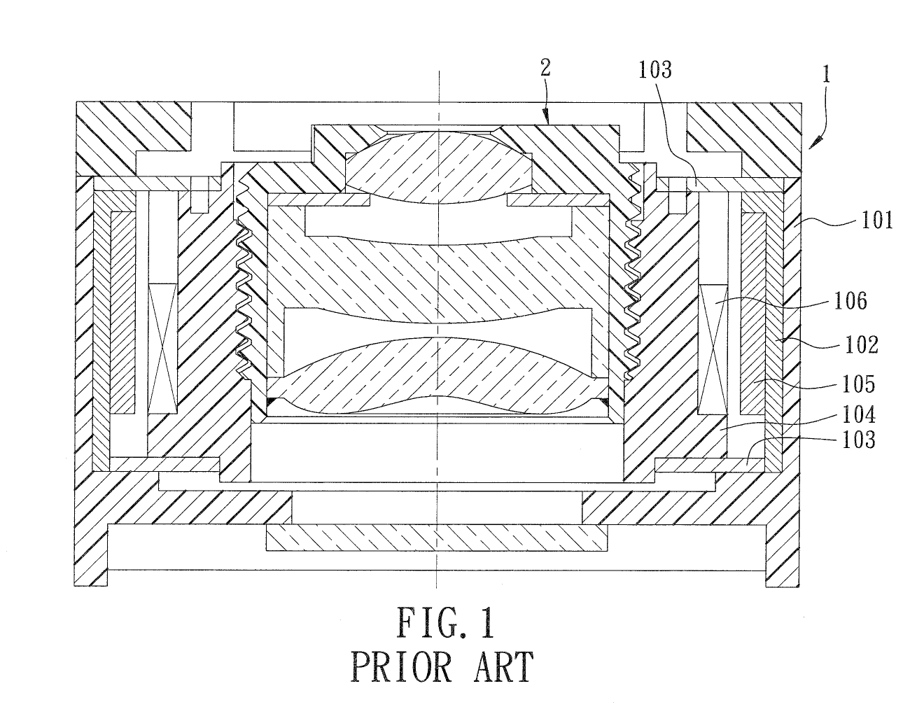

FIG. 2 is a plan view of a plate spring of the conventional auto-focusing lens device;

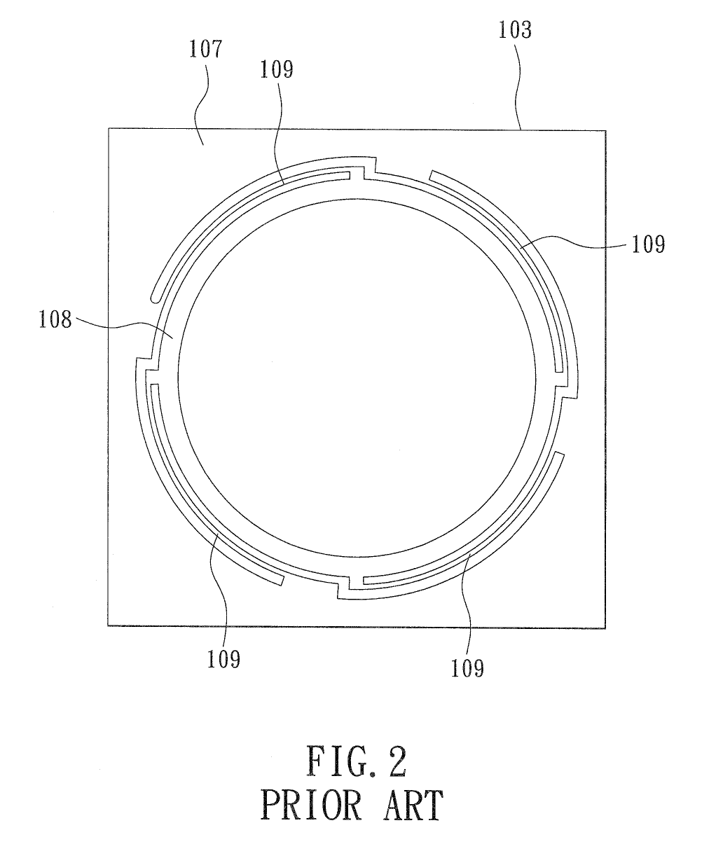

FIG. 3 is a plan view of a plate spring of a conventional camera module;

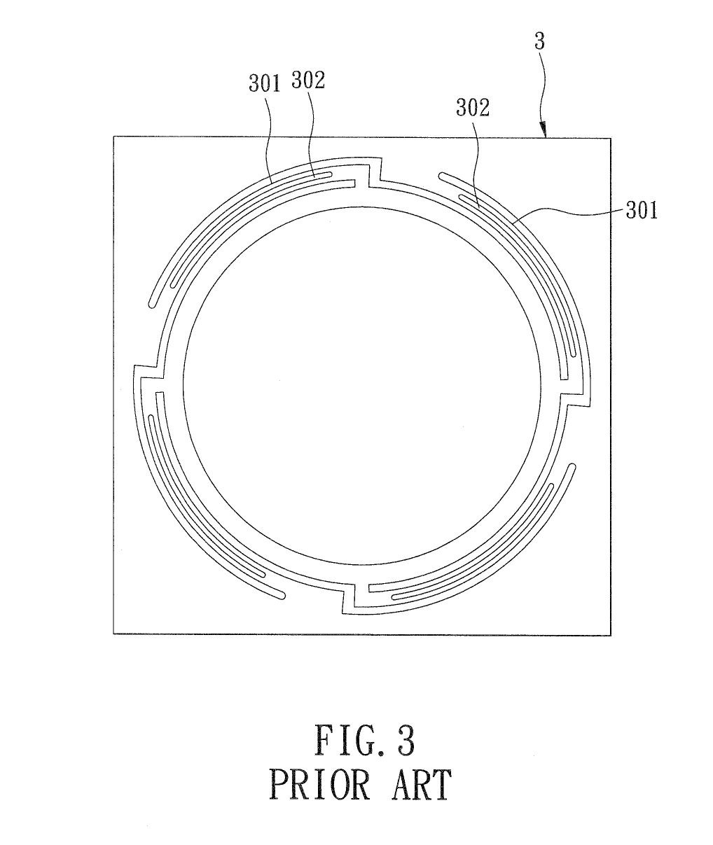

FIG. 4 is a perspective view of a preferred embodiment of a plate spring according to the present invention;

FIG. 5 is a plan view of the preferred embodiment; and

FIG. 6 is a table of simulation results comparing performance of the preferred embodiment with the prior art.

### DETAILED DESCRIPTION OF THE PREFERRED EMBODIMENT

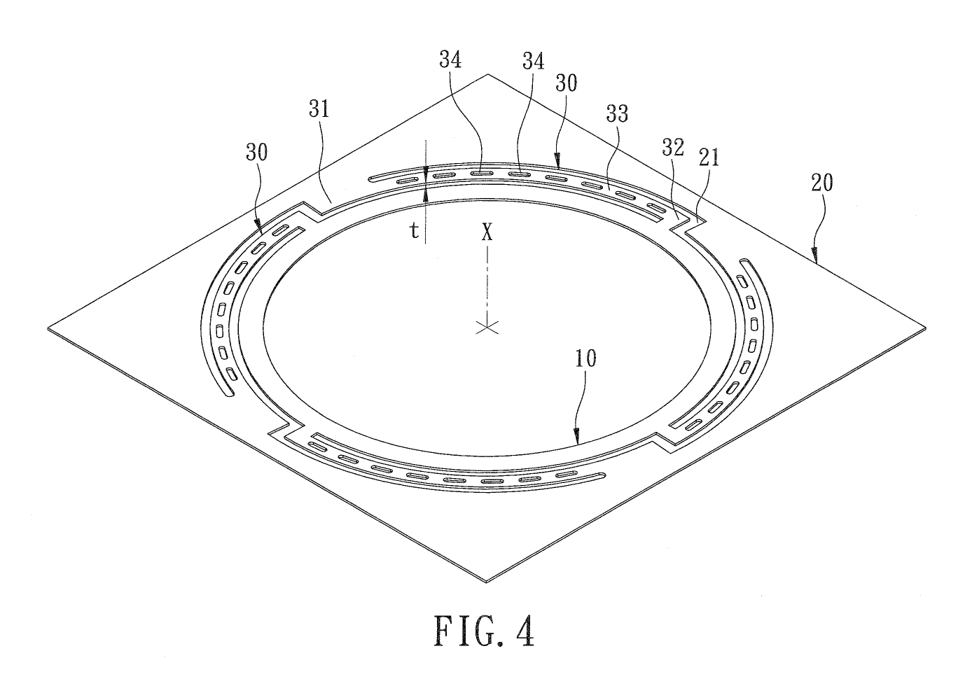

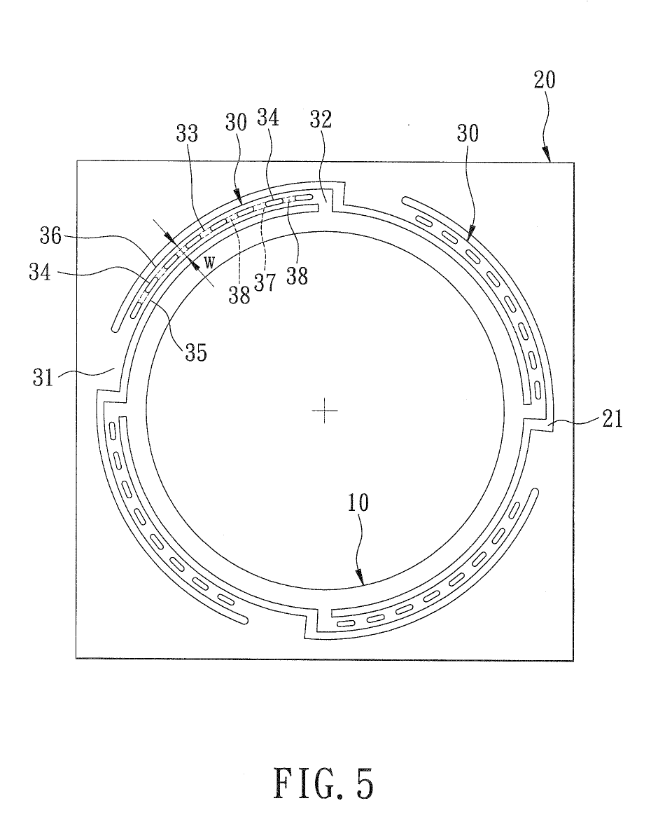

Referring to FIGS. 4 and 5, a preferred embodiment of a plate spring for a voice coil motor according to the present invention is shown to comprise an internal surrounding portion 10, an external surrounding portion 20, and a plurality of suspending arms 30.

The internal surrounding portion 10 is in a form of a ring that surrounds an axis (X). The external surrounding portion 20 surrounds the internal surrounding portion 10, is spaced apart from the internal surrounding portion 10, and has a plurality of cutouts 21. The suspending arms 30 interconnect the internal surrounding portion 10 and the external surrounding portion 20, and extend into the cutouts 21, respectively.

Each of the suspending arms 30 includes a first connecting segment 31 that is connected to the external surrounding portion 20 and that extends radially inward, a second connecting segment 32 that is connected to the internal surrounding portion 10 and that extends radially outward, and a working segment 33 that curves about the axis (X) that extends between and interconnects the first and second connecting segments 31, 32, and that has an inner edge 35 facing toward the internal surrounding portion 10, an outer edge 36 facing toward the external surrounding portion 20, a slit 37 being defined between the inner and outer edges 35, 36, and a plurality of bridge portions 38 interconnecting the inner and outer edges 35, 36 and dividing the slit 37 into a plurality of hole portions 34 which are angularly spaced apart from each other.

The working segment 33 has a radial width (w) defined between the inner edge 35 and the outer edge 36, and a thickness (t) along an axial direction. The width (w) ranges between 0.22 mm and 0.4 mm. The thickness (t) ranges between 0.035 mm and 0.055 mm. In this embodiment, the width (w) is 0.3 mm, and the thickness (t) is 0.04 mm.

A ratio of a physical volume of the working segment 33 of each of the suspending arms 30 to a total volume of the hole portions 34 in the working segment 33 of each of the suspending arms 30 ranges between 3 and 24. In this embodiment, all of the hole portions 34 in each of the suspending arms 30 account for 4˜25 percent of the physical volume of the working segment 33 of each of the suspending arms 30 before the hole portions 34 are formed therein.

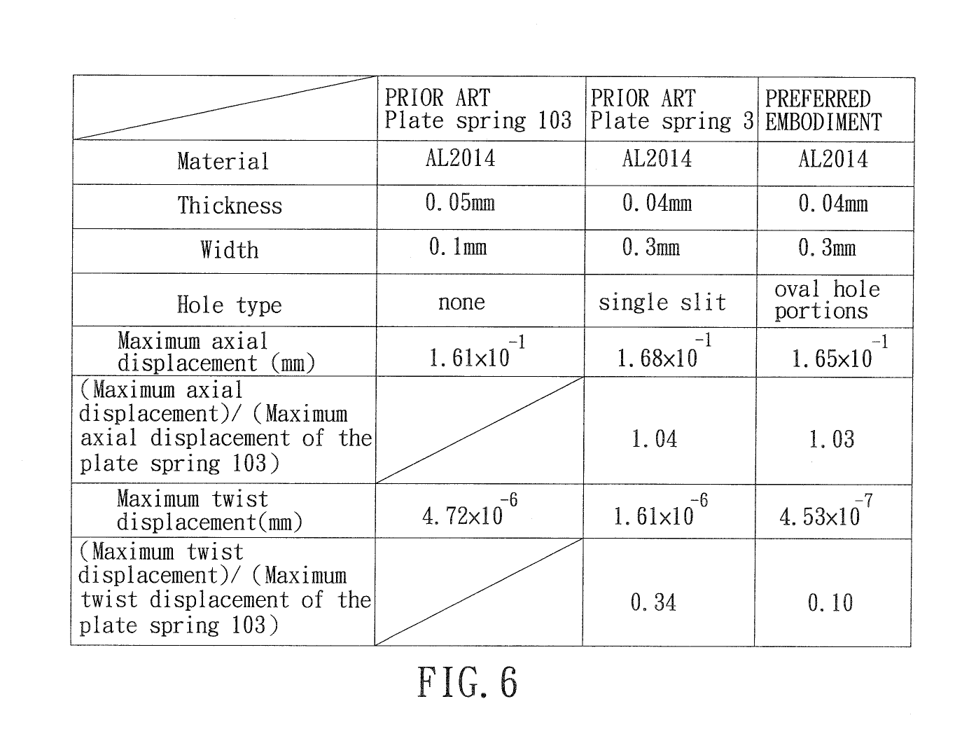

Referring to FIG. 6, a commercially available mechanical design software (e.g., Pro/Engineer developed by Parametric Technology Corporation) was used to simulate performance of the preferred embodiment and the prior art, i.e., the plate springs 103 and 3. The setting for material was aluminum alloy (e.g., AL2014), and upward axial thrust and rotation torque were set to be the same for the suspending arms 109, 301, and 30. The results of the simulation indicate:

i) The suspending arm 109 of the plate spring 103 has a maximum axial displacement of 1.61×10⁻¹ mm under the thrust, and a maximum twist displacement of 4.72×10⁻⁶ mm under the rotation torque.

ii) The suspending arm 301 of the plate spring 3 has a maximum axial displacement of 1.68×10⁻¹ mm under the thrust, and a maximum twist displacement of 1.61×10⁻⁶ mm under the rotation torque.

A ratio of the maximum axial displacement of the plate spring 3 to that of the plate spring 103 is 1.04. From Hooke's Law for axial loading in mechanics of materials, σ=E×ε, wherein σ is stress and E is a modulus of elasticity, both moduluses Es are formed to be almost identical.

A ratio of the maximum twist displacement of the plate spring 3 to that of the plate spring 103 is 0.34. From Hooke's Law for shear stress and shear strain in mechanics of materials, τ=G×γ, wherein τ is shear stress and G is a modulus of rigidity, G of the plate spring 3 is 2.9 times that of the plate spring 103.

iii) The suspending arm 30 of the present invention has a maximum axial displacement of 1.65×10⁻¹ mm under the thrust, and a maximum twist displacement of 4.53×10⁻⁷ mm under the rotation torque.

A ratio of the maximum axial displacement of the preferred embodiment to that of the plate spring 103 is 1.03. Accordingly, both moduluses Es are formed to be almost identical.

A ratio of the maximum twist displacement of the preferred embodiment to that of the plate spring 103 is 0.1. G of the preferred embodiment is about 10 times that of the plate spring 103.

According to the aforementioned results, the advantages of the present invention can be summarized as follows:

i) Without changing axial elasticity of the plate spring, the present invention has an anti-torsion ability, which is 10 times that of the plate spring 103 of the prior art. Anti-torsion strength is thus enhanced significantly.

ii) Compared with the plate spring 3 of the prior art, while the anti-torsion ability of the present invention is 10 times that of the plate spring 103, G of the plate spring 3 is only 2.9 times that of the plate spring 103. Therefore, the anti-torsion strength of the plate spring of the present invention is enhanced effectively.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A plate spring for a voice coil motor, comprising:
an internal surrounding portion;
an external surrounding portion that surrounds said internal surrounding portion and that is spaced apart from said internal surrounding portion; and
a plurality of suspending arms that interconnect said internal surrounding portion and said external surrounding portion, each of said suspending arms including
a first connecting segment that is connected to said external surrounding portion and that extends inwardly,
a second connecting segment that is connected to said internal surrounding portion and that extends outwardly, and
a working segment that interconnects said first and second connecting segments and that is formed with a plurality of hole portions which are spaced apart from each other.

2. The plate spring as claimed in claim 1, wherein said working segment has an inner edge facing toward said internal surrounding portion, an outer edge facing toward said external surrounding portion, a width defined between said inner edge and said outer edge, and a thickness along an axial direction, said width ranging between 0.22 mm and 0.4 mm, said thickness ranging between 0.035 mm and 0.055 mm.

3. The plate spring as claimed in claim 2, wherein a ratio of a physical volume of said working segment of each of said suspending arms to a total volume of said hole portions in said working segment of each of said suspending arms ranges between 3 and 24.

4. The plate spring as claimed in claim 3, wherein said internal surrounding portion is in a form of a ring that surrounds an axis, said first connecting segment of each of said suspending arms extending radially inward, said second connecting segment of each of said suspending arms extending radially outward, said working segment of each of said suspending arms curving about the axis and extending between said first and second connecting segments, said width of said working segment of each of said suspending arms being a radial width, said hole portions in said working segment of each of said suspending arms being angularly spaced apart from each other.

5. A plate spring for a voice coil motor, comprising:
an internal surrounding portion;
an external surrounding portion that surrounds said internal surrounding portion and that is spaced apart from said internal surrounding portion; and
a plurality of suspending arms that interconnect said internal surrounding portion and said external surrounding portion, each of said suspending arms including
a first connecting segment that is connected to said external surrounding portion and that extends inwardly,
a second connecting segment that is connected to said internal surrounding portion and that extends outwardly, and
a working segment that interconnects said first and second connecting segments and that has an inner edge facing toward said internal surrounding portion, an outer edge facing toward said external surrounding portion, a slit being defined between said inner and outer edges, and a plurality of bridge portions interconnecting said inner and outer edges and dividing said slit into a plurality of hole portions.

6. The plate spring as claimed in claim 5, wherein said working segment has a width defined between said inner edge and said outer edge, and a thickness along an axial direction, said width ranging between 0.22 mm and 0.4 mm, said thickness ranging between 0.035 mm and 0.055 mm.

7. The plate spring as claimed in claim 6, wherein a ratio of a physical volume of said working segment of each of said suspending arms to a total volume of said hole portions in said working segment of each of said suspending arms ranges between 3 and 24.

8. The plate spring as claimed in claim 7, wherein said internal surrounding portion is in a form of a ring that surrounds an axis, said first connecting segment of each of said suspending arms extending radially inward, said second connecting segment of each of said suspending arms extending radially outward, said working segment of each of said suspending arms curving about the axis and extending between said first and second connecting segments, said width of said working segment of each of said suspending arms being a radial width, said hole portions in said working segment of each of said suspending arms being angularly spaced apart from each other.
